(19) United States
(12) Patent Application Publication
(10) Pub. No.: US 2017/0098174 A1
(43) Pub. Date: Apr. 6, 2017

(54) System and Method for Utilizing Restaurant Services

(71) Applicant: Prasad Venigalla, Glen Head, NY (US)

(72) Inventor: Prasad Venigalla, Glen Head, NY (US)

(21) Appl. No.: 14/873,559

(22) Filed: Oct. 2, 2015

(51) Int. Cl. G06Q 10/02; G06Q 50/12

(52) U.S. Cl. CPC G06Q 10/02; G06Q 50/12

(57) ABSTRACT

A system and method designed to increase the operating efficiency of a restaurant by decreasing the customer waiting times during the dining experience. Application software is provided that is utilized by both the restaurant and patrons over a computer network. The application software creates reservations for patrons on selected dates and at selected times. A first patron selects a date and time for a reservation. The patron also identifies other patrons with whom the first patron would like to share the reservation. The application software automatically sends an electronic invitation to the other selected patrons. The reservation is then updated to include the other patrons who responded positively. All the patrons who join in on a reservation are invited to place preliminary orders. The orders placed by any one patron for a reservation can be viewed by all the patrons participating in the reservation. Although each patron is part of the same reservation, each patron can maintain a separate bill for the item that he/she adds to the order.

### BACKGROUND OF THE INVENTION

1. Field of the Invention

In general, the present invention relates to computer-based operating systems and software that enable a patron to select, order and pay for food at a restaurant. More particularly, the present invention relates to systems and software that enable multiple patrons from different locations to conference in to a common restaurant reservation and/or order that was initiated by friends or family.

2. Prior Art Description

The operation of a restaurant is one of the oldest professions that exist. Throughout this long history, the success of any restaurant has always been determined by customer satisfaction. If a customer is happy with a restaurant, the customer returns and recommends the restaurant to others. The restaurant's business then thrives. Customer satisfaction, however, has many facets. In order for a customer to like a restaurant and want to visit it again, several factors are considered. Those factors include meal quality, meal size, seating comfort, price, waiting time, service quality and many intangibles that provide a restaurant with its unique ambiance.

Restaurant owners have good control over many of the factors, such as meal quality, meal size, and price. However, many other factors, such as waiting time and seating comfort are often left to chance. For example, a restaurant cannot control how many people show up at a given moment without reservations. A restaurant may therefore be very crowded on certain days and empty on others. Furthermore, patrons are typically seated in a restaurant as soon as a table becomes available. This may cause certain areas of a restaurant to become crowded and loud, while other sections are less crowded.

Many restaurants have a host or hostess, whose job is to control the flow of patrons in a restaurant. The host/hostess tries to distribute patrons evenly throughout the restaurant. This works well when the restaurant is empty. However, when the restaurant is full and people are waiting to be seated, the system breaks down and people are seated wherever a seat opens. Thus, many factors that contribute to customer satisfaction are left to chance.

When a restaurant becomes overcrowded, people tend to enjoy the restaurant less. In an over crowded restaurant, service tends to be slower since the kitchens are busy and the servers have less time to spend at any one table. Consequently, many restaurants suffer from their own success. As a restaurant becomes successful and busy, customer satisfaction with the restaurant decreases and the popularity of the restaurant may wane.

It is therefore very important that a restaurant maintain certain standards with regard to service as the restaurant becomes more and more successful. The key to maintaining high standards in a busy restaurant is efficiency. Whenever the efficiency of the service in a restaurant can be improved, less time is wasted and better service can be provided to the customers. By providing better service to the customers, the customers' satisfaction can be increased and a restaurant can become and remain successful.

In the prior art, there are many operating systems for restaurants that are designed to increase the efficiency in some aspect of the running of a restaurant. For example, in most all modern fast food restaurants, there is a push button ordering pad at the cashier. When a customer orders food, the order is immediately entered into the ordering pad. The order is electronically forwarded to the kitchen so that the order can be filled. Simultaneously, the price of the order is calculated. This efficient communication between the kitchen and the customer increases the efficiency of the restaurant and the speed at which a customer's order can be filled.

With the advancements in digital systems and devices, such as smart phones, many restaurants have found ways that they can improve efficiencies using software. Using a smart phone, many restaurants now enable people to review menus, place orders and pay for the food before that person even arrives at the restaurant. Such prior art systems are exemplified by U.S. Patent Application Publication No. 2011/0029335 to Lutnick, and U.S. Patent Application No. 2003/0078793 to Toth.

Although many systems and software applications enable a person to quickly order from restaurants, such prior art systems tend to take away from the social aspects of a restaurant. Ordering food, using a smart phone application, eliminates discussions between friends at a restaurant table or tables when seated at multiple tables due to size of the group regarding what to order. It also prevents friends from purposely ordering different things so that different foods can be shared at the table. A need therefore exists for a system and software that provides the convenience of ordering using a smart phone software application, yet returns some of the social interaction of friends into the ordering process by exchanging data among friends. This need is met by the present invention as described and claimed below.

### SUMMARY OF THE INVENTION

The present invention is a system and method of creating a reservation at a restaurant in a manner that increases the operating efficiency of a restaurant by decreasing the customer waiting times. Application software is provided that is utilized by both the restaurant and patrons over a computer network. The application software creates reservations for patrons on selected dates and at selected times.

The reservation system is initiated by a first patron using the application software. The first patron selects a date and time for a reservation. The patron also identifies other patrons with whom the first patron would like to share the reservation. The application software automatically sends an electronic invitation to the other selected patrons. The invitation prompts the other patrons to provide a positive response if they intend to join in said reservation. The reservation is then updated to include the other patrons who responded positively.

All the patrons who join in on a reservation are invited to place preliminary orders. The orders placed by any one patron for a reservation can be viewed by all the patrons participating in the reservation. Although each patron is part of the same reservation, each patron can maintain a separate bill for the item that he/she adds to the order.

By enabling parties to join in on reservations and food orders and preorder food, the time wasted at a restaurant is greatly reduced. The restaurant benefits by being able to serve more patrons in a given period of time. The patrons benefit by having an improved experience without having to wait for service and food. It allows restaurant to up sell by offering coupons, discounts to lure customer to order desserts/drinks which otherwise may not be ordered. When order is placed and if a patron needs to make change or add or delete or specific instructions on how food is to be prepared (well-done/spicy/mild) could be requested through the application software directly with chef. The application software provides interaction between the waiter, chef, patron, and management.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic showing the requirements of the present invention restaurant operating system and software;

FIG. 2 is a block diagram schematic of the overall methodology of the restaurant operating system and software;

FIG. 3 is a block diagram schematic illustrating the substeps contained in making a reservation using the restaurant operating system and software; and

FIG. 4 is a schematic illustrating the substeps contained in paying a bill using the restaurant operating system and software.

### DETAILED DESCRIPTION OF THE DRAWINGS

Although the present invention system and software can be embodied in many ways, only one exemplary embodiment has been selected for the purposes of illustration and discussion. The illustrated embodiment, however, is only exemplary and should not be considered a limitation when interpreting the scope of the appended claims.

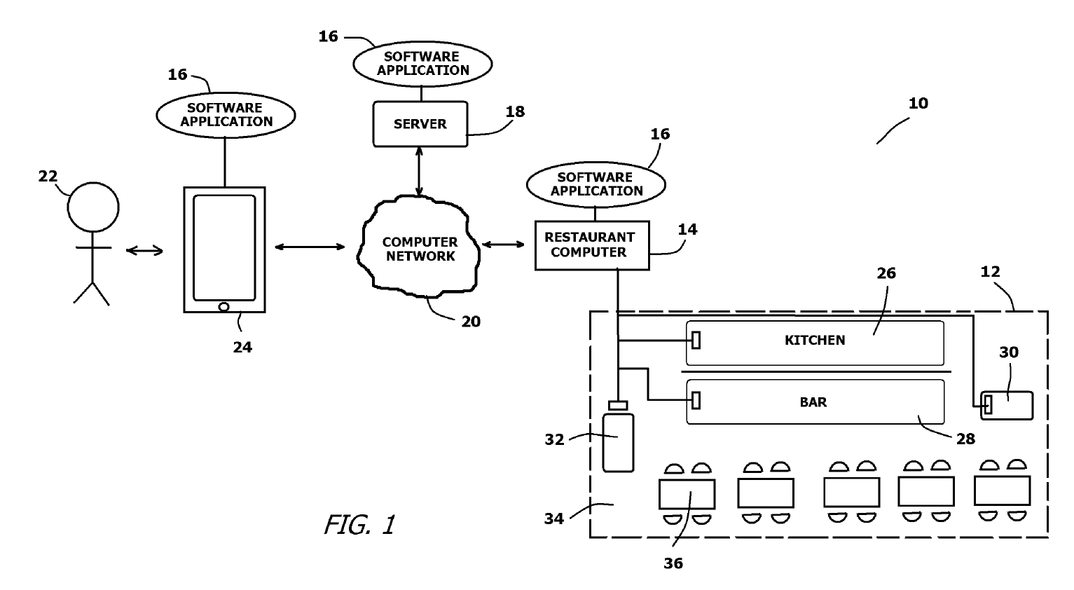

Referring to FIG. 1, the system requirements of the present invention system and software 10 are shown. In order to utilize the present invention system and software 10 for a particular restaurant 12, the restaurant 12 would have to agree to participate. The restaurant 12 would have to upload its menu, costs, and other information to the system. This would be done using the restaurant's computer 14 and the restaurant's end of the application software 16. The restaurant's computer 14 communicates with one or more servers 18 using a computer network 20, such as the World Wide Web. The servers 18 run the integrated server end of the application software 16. The application software 16 run by the servers 18 is accessed by restaurant patrons 22 over the computer network 20 using a smart phone 24 or equivalent computing device, such as a laptop, that runs the integrated user end of the same application software 16.

Included in FIG. 1, is a schematic of an exemplary restaurant 12. The restaurant 12 has a kitchen 26, bar 28, waiter stations 30 and a hostess station 32. The restaurant 12, of course, also has a dining room 34 with tables 36. The patrons of the restaurant can order food to go or can sit at the tables 36 in the dining room 34 to eat.

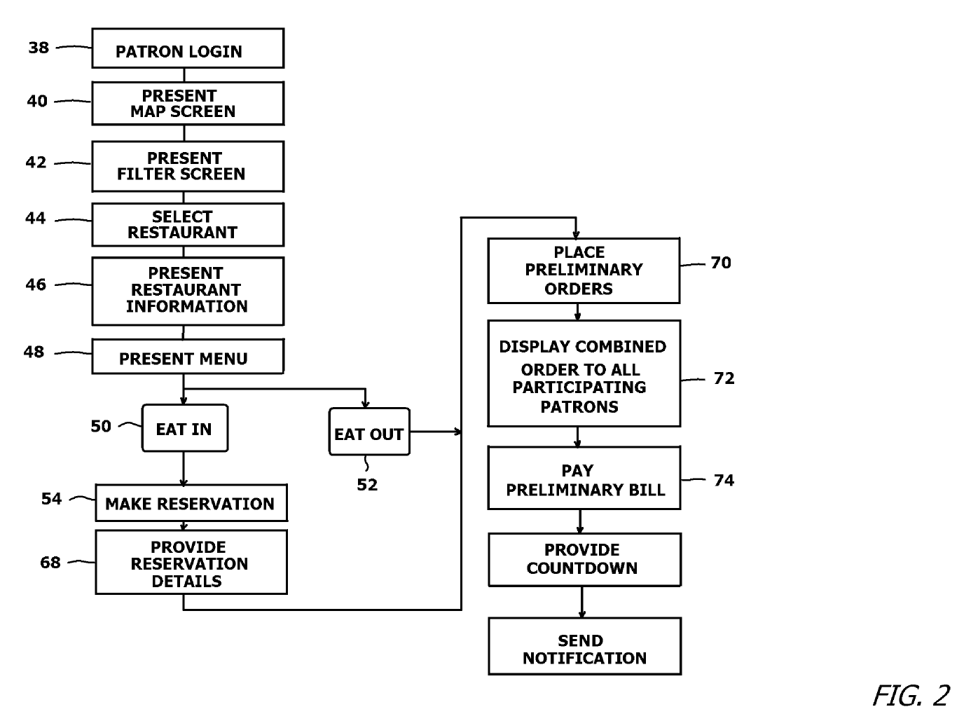

Referring to FIG. 2 in conjunction with FIG. 1, the general operating methodology of the present invention system and software 10 can be explained. A potential patron 22 logs into the system. See Block 38. The application software 16 can present the patron 22 with previously selected favorite restaurants. However, assuming that the patron 22 is new to the area, a map screen is presented that shows the location of the patron and the location of the nearest participating restaurants. See Block 40. A filter screen can then be used by the patron 22 to narrow the selection based upon various search criteria, such as food type, location, entry cost, liquor license type, and the like. See Block 42.

Once a patron 22 selects a restaurant, the patron 22 is presented with an information screen. See Block 44 and Block 46. The information screen shows details about the restaurant, such as pictures, Zagat® ratings, reviews and the like. If the patron 22 is interested, the patron 22 advances to the menu screen. See Block 48. On the menu screen the patron 22 can see the menu, the specials, and the prices. Furthermore, on the menu screen, the patron 22 indicates if he/she is interested in eating at the restaurant or ordering takeout. See Block 50 and Block 52. If the patron is ordering take-out, then the patron is advanced to the ordering screen.

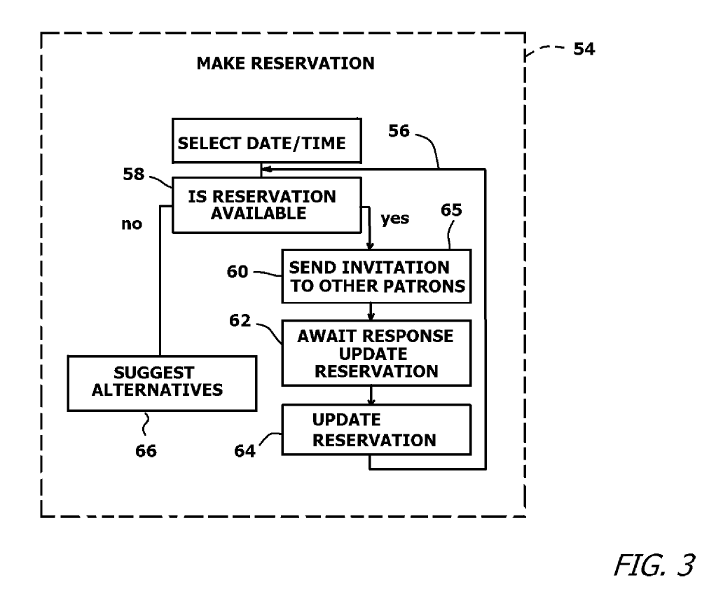

If the patron 22 is planning to eat at the restaurant 12, the patron 22 is advanced to a reservation screen. See Block 54. At the reservation screen, the patron 22 can select a date and time that the patron would like to eat. Referring to FIG. 3 in conjunction with FIG. 2, it can be seen that the step of making a reservation presents options to the patron 22. First, the application software 16 checks to see if the date and time selected are available. See Block 56 and Block 58. If the reservation is available, the application software 16 prompts the patron 22 to invite others to join in the reservation. See Block 60. If the patron 22 elects to invite others, the others are identified and a message is automatically sent to the others informing them of the invitation to join the reservation. The message may be sent via text, e-mail or through a social networking cite.

Using the same application software 16, the others that are invited can respond to the invitation within a predetermined period of time. If invited others agree to join the reservation, the reservation is updated. See Block 62 and Block 64. The update is checked by the restaurant to ensure there is enough seating for all those who join the reservation. See loop line 65. The restaurant may have to seat larger parties at different tables. However, the application software still enables all the patrons to be treated as a single party. In this manner, the bill, ordering and service can be unified among the various tables.

If the restaurant 12 cannot accommodate a reservation or cannot accommodate an update to a reservation, then the application software 16 can suggest a new date and/or time when the reservation can be accommodated. See Block 66. Alternatively, the application software 16 can inform the patrons that the party size is too large to be accommodated and display the number of patrons that can be accommodated at the originally selected date and time.

Returning to FIG. 2, it can be seen that if a reservation date and time are accepted, the patrons involved in the reservation are provided with some additional information. That information may include information about the table where they will be seated, the name of waiters/waitresses scheduled to work at that time, the name and type of entertainment offered at that time, and the name of the chef cooking at that time. See Block 68.

The application software 16 now knows the date and time of a reservation and the number of patrons who will be dining as part of that reservation. Using the application software 16, all patrons who are part of the reservation are invited to place a preliminary order electronically. See Block 70. Each patron can place his or her own order. However, patrons can place orders for themselves and others if they prefer. As the order is placed, the application software 16 displays the combined order to all participants. See Block 72 In this manner, each person ordering can see the types of appetizers, entrees, and desserts being ordered and by whom. This prevents undesired double ordering within the same party. Using the application software 16, the restaurant can offer specials and promote different meals, drinks and desserts by offering instant discounts on promoted items.

Using the present invention system and software, the patrons are presented with the option of preordering at the time the reservation is made. The patrons who are part of a reservation can then preselect the drinks, appetizers, entrees, and desserts that they would like when they arrive at the restaurant 12. The restaurant 12, having the preorder, will prepare the order and have the food and drinks ready at the restaurant 12 at the reserved time. Since the food and drinks will be prepared prior to the arrival of the patrons, prepayment for the food and drink may be required. The payment may be just a deposit, such as fifty percent of the cost of the order.

The application software 16 also enables the patrons to interact with the waiter and chef directly. As such, custom orders can be placed. Likewise, special instructions, can be provided regarding the degree of cooking, the degree of spices, unusual allergies and the like. Furthermore, the patron can watch prerecorded videos on how the food is prepared and can watch the kitchen through a camera to see the food actually being prepared.

Using the application software, the patron can also interact with the waiter staff to request water, bread, utensils, removal of plates of the like. This makes the restaurant staff both more efficient and less obtrusive.

By ordering at the time of making the reservation, many efficiencies are achieved. A patron will no longer have to wait a long period of time for a meal to be prepared. This time savings is especially relevant for larger parties who dine together and would otherwise have to wait a very long time for all the ordered meals to be prepared. Similarly, people on a lunch break can eat quickly without having to worry about kitchen delays during the busy lunch hour. The food, therefore, can be timed and be made ready as soon as the patron is seated and is ready to be served.

Another efficiency obtained from preordering is that a chef can determine ahead of time how much of certain dishes will be required. A chef, therefore, can make larger batches, or smaller batches of various dishes depending upon the demand for that dish on a particular day.

After the food and drinks are ordered, the preliminary bill is paid. See Block 74. Each patron that orders through the application software 16 is assigned a separate bill. In this manner, large parties can easily split the bill. However, the bills can also be combined in part or in full by one person in the reservation by merely indicating through the application software 16 that he/she is willing to do so. This can be done on a first-to-select basis. In this manner, the first person to volunteer to pay for another can do so without argument from others. This reduces occurrences of patrons in a large party arguing over the bill.

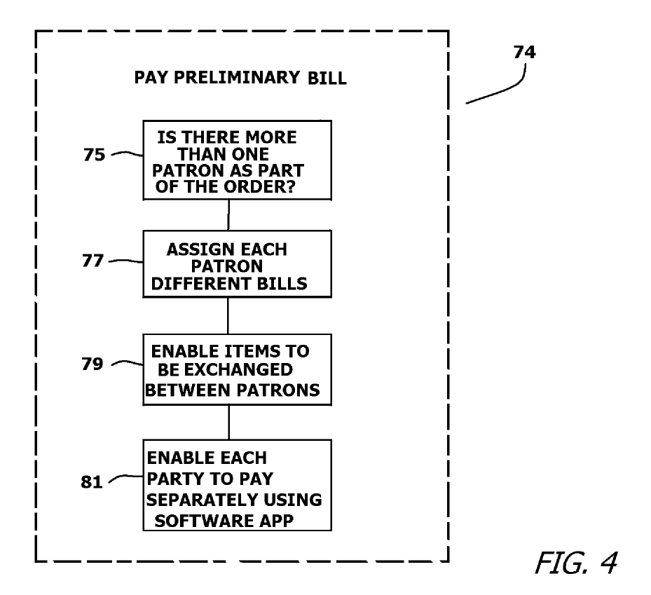

The substeps involved in paying the bill are shown in FIG. 4. Referring to FIG. 4, it can be seen that the application software determines if more than one patron is participating in the order. See Block 75. If more than one patron is participating, the orders of each patron are kept on separate bills, even though it is a single party. See Block 77. Using the software application, the different patrons can view the entire order and can switch and trade items ordered between the bills. See Block 79. Each patron can then pay his/her bill electronically using the software application. See Block 81.

Returning to FIG. 2, it can be seen that once the reservation process is complete, the patrons participating in the reservation are provided with a countdown reminder. See Block 83. The countdown reminder estimates when the order will be ready. This countdown can be weeks, days, or only minutes long. If a person is seated immediately, the time to when the order is ready may only be minutes away. However, for distant reservations, the countdown reminder is typically days long.

Once the time of a reservation has come to pass, the software application indicates that an order is ready. See Block 87. This informs patrons that they are about to be served. This eliminates waiting anxiety and adds to the satisfaction of the patrons.

Returning FIG. 1 in conjunction with FIG. 2, it can be seen that once a reservation is made, the restaurant 12 awaits the arrival of the patron 22 at the reserved time. If a patron has preordered and prepaid for food or drinks, the order is automatically sent to the kitchen 26 or bar 28 just prior to the scheduled arrival time of the patron. The order is sent to the kitchen computer terminal and/or bar terminal by the restaurant's computer 14. The patrons are informed of the wait time until the order is ready.

As the reservation time approaches, the reservation information is also forwarded to the hostess station 32 by the restaurant's computer 14. In this manner, the hostess can anticipate the arrival of the customers.

A layout of the restaurant's seating is displayed at the hostess station 32. The hostess station 32 is used by the hostess to input where patrons have been seated in the restaurant 12. The application software 16 can run an algorithm to help seat arriving patrons. From the reservation data, the application software 16 knows the number of seats needed to accommodate a particular reservation. The application software 16 also knows where patrons have previously been seated and how long ago they were seated. From this information, the application software can determine which areas in the restaurant can seat the arriving customers. Several areas of the restaurant may be adequate, especially if the arriving customers are in a small party.

Once the patrons arrive, they are seated at their assigned seats. Ideally, the seats will be ready at the time made for the reservation. Once the determination of seating is made, that information is sent to the waiter that will be responsible for service. The proper table and seat arrangements should therefore be ready for a reservation and patrons need not wait once they arrive at the restaurant.

Once the customers are seated, a waiter confirms the preplaced order, amends the preplaced order or takes a new order. The waitress can then visualize which preordered items belong to each of the seating positions at the table. In this manner, when the food is brought to the table, the waitress knows what patrons are to be served the various food and drinks that were ordered.

Using statistical analysis of incoming data, a restaurant can track trends. For example, a restaurant can track what types of meals are ordered most often and at what time. A restaurant can therefore make changes to its menu to follow the ordering trends of its customers. For example, if fish meals are very popular, a restaurant may try offering more types of fish meals. Since data regarding meals and drinks served is being collected, a restaurant can also utilize the restaurant operating system to track inventory. Furthermore, the time spent in the restaurant by different waitresses can also be readily tracked. The price of meals served by the different waitresses can be tracked, therefore the tips of the waitresses can be determined either for the purposes of income tax and/or sharing the tips with the hostess and bus services.

When restaurant does not offer reservations or patrons do not make reservations, the software application 16 can be used in place of the traditional wait list or buzzer. The software application provides a wait time clock and alert notice when the restaurant is ready to seat a customer. The software application 16 enables the restaurant to prepare the food order as the patrons are waiting to be seated. In this manner, they can be served as soon as they are seated. This saves time for both the patron and restaurant. It also enables the restaurant to turnaround tables quickly.

Restaurants often have excess food at the end of a business day in the form of soups, bread, salads and many other entrees that cannot be sold on subsequent days. The application software 16 enables this excess food to be offered to the public or a charity at the end of the day at discounted prices. In this manner, a restaurant produces less waste and does more for the community.

It will be understood that the embodiment of the present invention restaurant operating system is merely exemplary and that a person skilled in the art can make many changes to the shown embodiment using functionally equivalent method steps. Furthermore, it is understood that the overall operating system is software based and that different programmers, using different programming languages would write the program code differently. However, all such programs that accomplish the described methodology of the present invention are intended to be included within the scope of the present invention as set forth by the claims.

What is claimed is:

1. A method of creating a reservation at a restaurant, said method comprising the steps of:
providing application software that creates reservations on selected dates and at selected times for a restaurant, wherein said application software is accessible to patrons of said restaurant through a computer network;
prompting a first patron using said application software to select a date and time for a reservation;
prompting said first patron to invite a second patron to join in said reservation, wherein said application software automatically generates an electronic invitation that is sent to said second patron that invites said second patron to provide a positive response to join in said reservation;
updating said reservation with each said positive response to said electronic invitation, therein creating an updated reservation.

2. The method according to claim 1, further including the step of having said first patron and said second patron preorder through said application software, wherein said application software informs said first patron and said second patron of the other order.

3. The method according to claim 1, further including the step of having said application software maintain separate bills for said first patron and said second patron.

4. The method according to claim 1, further including the step of informing said first patron about staffing at said restaurant at said date and said time of said reservation, wherein said staffing includes information selected from a group consisting of names of waiters, names of chefs, and names of live entertainment.

5. The method according to claim 1, further including the step of checking if said updated reservation can be accommodated by said restaurant at said date and said time.

6. The method according to claim 5, wherein said application software offers alternatives to said date and said time if said updated reservation cannot be accommodated.

7. A method of creating a reservation at a restaurant or a group of patrons that include a first patron and a second patron, said method comprising the steps of:
providing application software that creates reservations on selected dates and at selected times for a restaurant, wherein said application software is separately accessible to said first patron and said second patron through a computer network;
prompting said first patron, using said application software to place an order with said restaurant;
prompting said second patron, using said application software, to add to said order, wherein said application software displays said order to said first patron and said second patron simultaneously;
maintaining separate bills for said order between said first patron and said second patron.

8. The method according to claim 7, further including the step of having said first patron make a reservation at said restaurant using said application software.

9. The method according to claim 8, further including the step of prompting said first patron to invite said second patron to join in said reservation, wherein said application software automatically generates an electronic invitation that is sent to said second patron that invites said second patron provide a positive response to join in said reservation.

10. The method according to claim 7, further including the step of informing said first patron about staffing at said restaurant, wherein said staffing includes information selected from a group consisting of names of waiters, names of chefs, and names of live entertainment.

11. The method according to claim 7, further including the step of recalling and filling said order prior to said reservation so that said order is ready to be served when said first patron and said second patron arrive at said restaurant for said reservation.

12. A method of operating a restaurant, comprising the steps of:
taking an order of menu items over a computer network, wherein said order is placed by a first patron;
electronically inviting other patrons, selected by said first patron, to add to said order, wherein said order is displayed to any of the other patrons that adds to said order;
maintaining a separate bill for each of said other patrons that add to said order.
